(19) United States
(12) Patent Application Publication
(10) Pub. No.: US 2002/0073972 A1
(43) Pub. Date: Jun. 20, 2002

(54) Fuel-drawing device for a motor vehicle tank

(76) Inventors: Pascal Orsini, Nuisement-sur-coole (FR); Frederico Vilela, Chalons en champagne (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/017,825

(22) Filed: Dec. 13, 2001

(30) Foreign Application Priority Data
Dec. 14, 2000 (FR) 00 16296

(51) Int. Cl. F02M 37/04

(52) U.S. Cl. 123/497

(57) ABSTRACT

The present invention relates to a fuel drawing-off device for a motor vehicle tank, the device comprising a drawing-off pump and a fine filter placed upstream from the pump, wherein the drawing-off pump is a pilot operated pump.

The present invention relates to the field of systems for drawing fuel from a motor vehicle tank.

### BACKGROUND OF THE INVENTION

Numerous systems have been proposed for this purpose.

In general, systems for drawing fuel from a motor vehicle tank comprise an electric pump which sucks fuel in from the tank or from a supply situated within the tank.

The object of such a supply is to limit the amount of fuel movement in the vicinity of the suction inlet of the pump, as can result from acceleration, deceleration, or centrifugal force whenever the vehicle is not following a rectilinear path.

Furthermore, known fuel-drawing systems generally include a coarse filter or strainer placed at the inlet of the pump, and a fine filter for guaranteeing the quality of the fuel that is forwarded to the engine.

In particular, such fuel-drawing systems have been proposed in which the fine filter is situated downstream from the electric pump, e.g. as described in document WO A 99/01658.

Known fuel-drawing systems have already given good service.

Nevertheless they do not give total satisfaction.

In particular, and in spite of a great deal of research, no satisfactory answer has yet been found to the various calls for progress to which the automobile industry is subject.

Firstly, it should be observed that when the fine filter is situated downstream from the pump, i.e. on the outlet duct therefrom, the fine filter is placed under pressure and its housing must consequently have mechanical strength that is suitable for withstanding the stresses due to said pressure.

That has led to a preference for putting the fine filter not downstream from the pump, but upstream therefrom, i.e. but at its inlet. That makes it possible to reduce certain stresses on the fine filter housing, and, where appropriate, also to omit the inlet strainer.

However, placing the fine filter upstream from the pump gives rise to other problems that have not yet been solved in satisfactory manner.

Firstly, the fine filter is sometimes the subject of significant clogging if it is placed upstream from the pump, particularly when the electric pump is associated with a supply which is itself fed by a jet pump, for example, receiving an inlet flow coming directly or indirectly from the outlet of the electric pump.

Secondly, on first starting of the system, or indeed after the system has become un-primed because of a low level of fuel, if the fine filter is situated upstream from the pump, then the electric pump must suck in a large volume of air which corresponds substantially to the volume of the housing for the fine filter.

Thirdly, it should be observed that until now, most electric pumps used in fuel-drawing systems have been rotary gear pumps. Such pumps operate on the principle of sucking liquid into the space lying between two consecutive teeth and then in causing it to pass to a delivery section.

However, nowadays, there is a strong demand for rotary gear pumps to be replaced by turbine or centrifugal pumps that can present genuine advantages. Turbine or centrifugal pumps are machines in which the rotation of a wheel or a rotor generates pressure and speed conditions that determine how a liquid flows in a circuit, with the magnitude of the flow being the result of equilibrium between the useful energy delivered by the pump per unit mass and the resistive energy per unit mass of the circuit.

Furthermore, nowadays, in numerous configurations, attempts at using turbine or centrifugal pumps for drawing fuel do not give satisfaction because of the problems of priming that are inherent to this type of pump. This problem is particularly acute for systems in which the fine filter is situated upstream from the pump because of the head loss generated by the filter.

Fourthly, it should be emphasized that turbine or centrifugal pumps generally possess a degassing orifice. When the pump is stopped, the presence of such a degassing orifice on the pump housing leads to contamination not only of the inside volume of the pump, but also of at least a portion of the volume of the fine filter housing connected thereto.

Fifthly, it should be emphasized that the presence of the degassing orifice in the pump housing can lead to a risk of the positive reserve associated with the pump emptying out via said degassing orifice, unless special precautions are taken.

### OBJECTS AND SUMMARY OF THE INVENTION

An object of the present invention is to improve known fuel-drawing systems in order to eliminate the above-specified drawbacks that are inherent to the prior art.

In the context of the present invention, this object is achieved by a fuel drawing-off device for a motor vehicle tank, the device comprising a drawing-off pump and a fine filter placed upstream from the pump, wherein the drawing-off pump is a pilot operated pump.

According to an advantageous characteristic of the present invention, the drawing-off pump is pilot operated in such a manner that the flow of fuel passing through the pump is close to the minimum flow required for proper operation of the device.

According to another advantageous characteristic of the present invention, the drawing-off pump is a brush-less pump.

### BRIEF DESCRIPTION OF THE DRAWINGS

Other characteristics, objects, and advantages of the present invention will appear on reading the following detailed description and on observing the accompanying drawings, which are given as non-limiting examples, and in which:

FIG. 1 is a diagrammatic vertical section view through a drawing-off device constituting a first embodiment of the present invention;

FIG. 2 is a similar vertical section view of a device constituting a second embodiment of the present invention;

FIG. 3 is a similar vertical section view of a third embodiment of the present invention, shown on non-coplanar planes referenced 3-3 in FIG. 4;

FIG. 4 is a horizontal cross-section view through the FIG. 3 device;

FIG. 5 is a diagrammatic longitudinal axial section view through a conventional jet pump of the prior art;

FIG. 6 is a diagrammatic longitudinal axial section view of a jet pump in accordance with the present invention; and

FIG. 7 is a diagrammatic longitudinal axial section view of a jet pump constituting a preferred variant of the present invention.

### MORE DETAILED DESCRIPTION

As mentioned above, the device of the present invention comprises an electric drawing-off pump 100 and a fine filter 210 placed upstream from the pump, i.e. at the inlet thereof.

Various configurations of the fine filter 210 are described in greater detail below.

Furthermore, in the context of the present invention, the drawing-off pump 100 is a pilot operated pump. Even more precisely, the drawing-off pump 100 is pilot operated in such a manner that the flow of fuel passing through it, and consequently also passing through the fine filter 210 placed upstream therefrom, is substantially equal to the flow required for proper operation as a function of the instantaneous consumption of the engine.

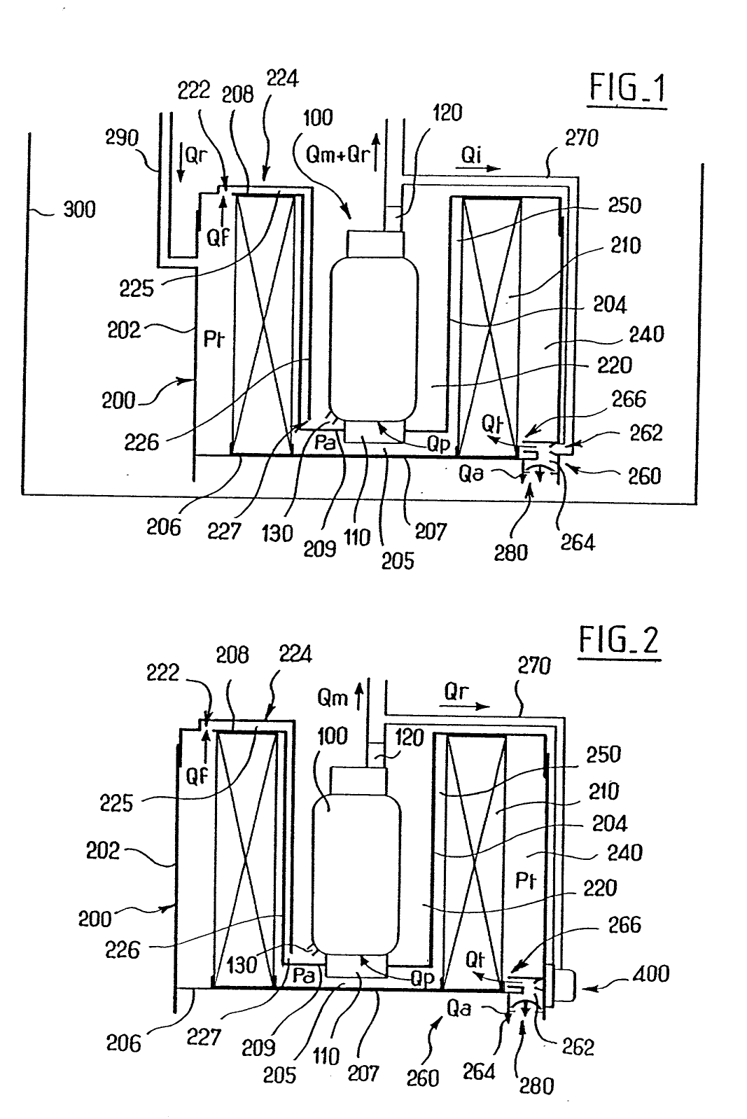

Thus, when the drawing-off pump 100 sucks from a supply fed by a jet pump that receives an inlet flow coming directly or indirectly from the outlet of the drawing-off pump, the drawing-off pump is pilot operated so as to deliver a flow that varies in such a manner that the flow passing through it and through the fine filter is substantially equal to the sum of the instantaneous consumption of the engine plus the auxiliary flow required for enabling the jet pump to operate. (The term “instantaneous consumption” of the engine is used herein to mean the actual instantaneous consumption of the engine, plus, where appropriate, any additional flow Qr that needs to be sent towards the engine in order to ensure that its injectors operate properly, but that is not actually consumed in practice, being returned to the drawing-off point (see FIG. 1)).

In contrast, when the drawing-off pump 100 takes fuel directly from the tank, the drawing-off pump is pilot operated so as to deliver a flow that varies in such a manner that the flow which passes through the pump and through the fine filter is substantially equal to the instantaneous consumption of the engine (in this case also, the term “instantaneous consumption” of the engine is used to mean the effective instantaneous consumption of the engine plus, where appropriate, any additional flow Qr that is sent to the engine in order to ensure that its injectors operate properly, but that is not consumed in practice, being returned to the drawing-off point (see FIG. 1)).

Thus, the present invention serves to limit the flow rate through the fine filter 210, and therefore serves to limit the head losses through the filter 210, the pressure at the inlet to the fine filter, the inlet pressure to the pump 100, and also clogging of the fine filter 210.

The drawing-off pump 100 can be pilot operated in various different ways.

The drawing-off pump 100 can be pilot operated by a pressure or flow rate sensor placed at the outlet from the pump. In principle, such a technique for regulating a pump is known to the person skilled in the art. It is therefore not described in detail below. It is merely recalled at this point that such regulation generally requires the pump to deliver some minimum flow rate on a continuous basis in order to ensure that it operates properly.

In another variant, the drawing-off pump 100 can be pilot operated by a reference coming from an engine control module, which reference is representative of the instantaneous consumption required by the engine. Under such circumstances, the pump 100 can be pilot operated from the control signal on the basis of curves of the pressure/flow rate or electrical current/speed kind.

Furthermore, as mentioned above in the context of the present invention, the drawing-off pump 100 is preferably a brush-less electric pump. Such a pump is itself well known to the person skilled in the art. Essentially it comprises a stator with coils and a rotor with a magnet.

The use of a brush-less pump 100 makes it possible to limit the risk of sending foreign bodies to the carburetor or to the injectors, and in particular shavings of metal or of plastics material, of the kind that can be removed as brushes move over an associated collector in an ordinary pump with brushes.

This advantage is clearly most important since the fine filter 210 is placed upstream from the drawing-off pump 100 and not downstream therefrom.

Various embodiments of the drawing-off device of the present invention are described below and shown in the accompanying figures.

The description begins with the embodiment shown in accompanying FIG. 1.

In FIG. 1, there can be seen a vertical axis pump 100. Most preferably it constitutes a pump turbine or centrifugal type of pump. As mentioned above, such a turbine or centrifugal pump possesses a wheel or rotor suitable for producing pressure and speed conditions that determine the flow of fuel in a circuit.

The inlet 110 of the pump 100 is placed at the bottom end of the pump. The outlet 120 is situated at the top end of the pump.

The pump 100 has a degassing orifice 130 which opens to the outside of the pump housing and which is situated in the vicinity of the bottom portion of the pump 100, just above the inlet orifice 110.

Accompanying FIG. 1 also shows a generally ring-shaped filter housing 200 centered on a vertical axis.

The housing 200 is defined essentially by a radially outer cylindrical wall 202, a radial inner cylindrical wall 204 coaxial with the above-specified wall 202, and two generally horizontal partitions 206 and 208 that are ring-shaped, respectively defining bottom and top portions of the housing 200.

The ring 208 is connected in leaktight manner to the top edges of the two cylindrical partitions 202 and 204.

The ring 206 is likewise connected to the bottom edge of the outer cylindrical partition 202. However, as described in greater detail below, it is not connected to the bottom of the radially inner cylindrical wall 204.

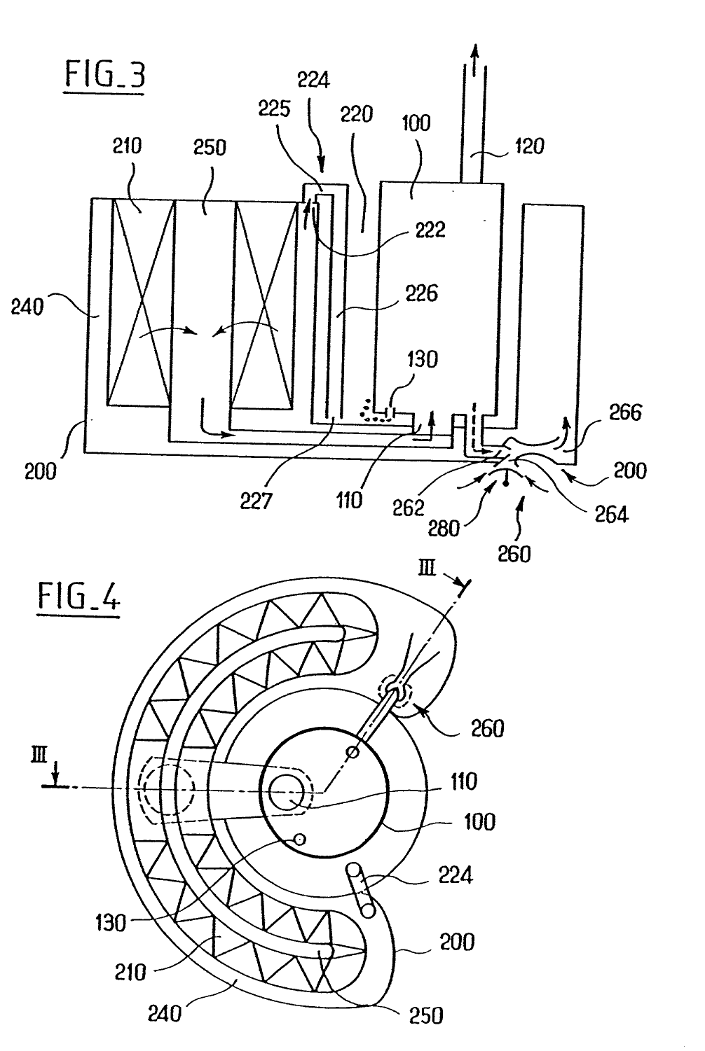

The housing 200 houses an annularly-shaped filter 210. However, as explained below in particular with reference to FIGS. 3 and 4, the housing 200 and the filter 210 could be of some other shape.

In FIG. 1, the pump 100 is placed in the central cavity 220 of the filter housing 200, i.e. the cavity defined inside the radially inner wall 204.

Leakproof connections are provided between each of the two ring-shaped walls 206, 208 of the housing 200 and the bottom and top portions respectively of the filter 210.

Thus, the housing 200 defines two chambers 240, 250 comprising respectively a radially inner chamber and a radially outer chamber relative to the filter 210.

The radially outer chamber 240 serves as an inlet chamber for the housing 200.

The radially inner chamber 250 serves as an outlet chamber.

For this purpose, in the central portion of the housing 200 the bottom ring-shaped wall 206 is extended by a leakproof partition 207, while the radially inner cylindrical wall 204 which defines the outlet chamber 250 and which is interrupted beyond the partition 207 is extended by a horizontal wall 209 parallel to the above-mentioned partition 207.

The two partitions 207, 209 thus define a cylindrical chamber 205 which communicates with the outlet chamber 250 of the filter housing. The inlet 110 of the pump opens out into said chamber 205. Furthermore, the partition 209 surrounds the inlet 110 of the filter in leaktight manner.

The inlet chamber 240 of the filter housing can be filled by any appropriate means from the tank 300.

The inlet chamber 240 is preferably filled using a jet pump 260 of general structure that is conventional.

The jet pump 260 possesses a converging nozzle 262 forming a driving Venturi which is fed with fuel, e.g. from a branch connection 270 connected to the outlet of the pump 100. The jet pump 260 also possesses a suction flow inlet 264 at its bottom portion which is protected by a check valve 280 such as an umbrella valve oriented to allow fuel to be transferred from the tank 300 towards the internal chamber of the jet pump 260 and then towards the inlet chamber 240, while preventing fuel from flowing in the opposite direction, i.e. from the inlet stage 240 and the inside volume of the jet pump 260 back towards the tank 300.

Finally, the jet pump 260 possesses a delivery outlet 266 which opens out into the inlet chamber 240 of the filter housing 200.

In a variant embodiment, the delivery outlet 266 of the jet pump 260 can be extended by a vertical pipe whose top end is situated in the vicinity of the top of the housing 200. Under such circumstances, there is no need to place a check valve 280 at the inlet for the sucked-in flow 264. Nevertheless, such a check valve can be provided at an arbitrary point on the inside wall of the housing 200 defining the inlet chamber 240 so as to allow fuel to be transferred from the tank towards the inlet chamber 240 when the level in the tank 300 is greater than the level in the inlet chamber 240.

It should also be observed that in the embodiment shown in FIG. 1, the flow Qr of fuel that is not consumed by the engine is returned via a duct 290 to the inlet chamber 240 of the filter.

Nevertheless, in a variant, this flow Qr from the duct 290 could be used for feeding the jet pump 260, and more specifically for feeding the converging nozzle forming the driving Venturi 262.

In another variant embodiment, it is possible to envisage using the return flow Qr in common with the branch flow Qi taken from the outlet of the pump 100 to feed the driving Venturi 262 of the jet pump 260 for the purpose of filling the inlet chamber 240 of the filter.

The flow of fuel Qp as sucked in through the inlet 110 of the pump 100 is equal to the sum of the flows Qm+Qr+Qi delivered via the outlet 220.

The flow Qt from the outlet 266 of the jet pump 260 is equal to the sum of the flow Qi coming from the branch connection 270 plus the flow Qa coming from the inlet 264.

To enable the filter housing 200 to be filled, the sum of the delivery flow rate Qr plus the flow rate Qt from the jet pump 260 must be greater than the sum of the flow rate Qp sucked in through the inlet 110 of the pump plus the flow Qf coming from the housing 200 via a degassing orifice 222 situated in the top portion of the housing 200, typically in the partition 208.

As can be seen on examining FIG. 1, the degassing orifice 130 of the pump 100 opens out into the central cavity 220 defined by the radially inner surface 204 of the filter housing 200.

It will also be observed on examining FIG. 1 that the structure of the present invention provides a large positive reserve volume for the pump 100, equal to the volume of the housing 200.

As mentioned above, the degassing orifice 222 of the filter housing 200 is placed in the top partition 208 and looks into the inlet chamber 240.

This orifice 222 opens out into a duct 224 having a segment 225 which is generally horizontal running over the top partition 208 and extended by a generally vertical segment 226 which runs over the radially inner wall 204 down to the base of the cavity 220. The end segment 226 of the duct 224 thus possesses an opening 227 situated close to the partition 208 in the vicinity of the degassing orifice 130 of the pump 100.

The opening 227 of the duct 224 is situated at a height that is equal to or lower than the height of the degassing orifice 130 of the pump 100.

The opening 227 of the duct 224 is preferably situated beneath the level of the degassing orifice 130 of the pump 100. Also preferably, the diameter of the duct 124 is at least slightly greater than the diameter of the degassing orifice 130 of the pump 100.

By means of these characteristics, the duct 224 constitutes a siphon suitable for delivering the fuel present in the central cavity 220 as defined by the pump housing 200 towards the inlet chamber 240 of the filter in the event of the pump 100 stopping, thereby preventing fuel entering the pump via the degassing orifice 130, which fuel might contaminate the pump 100.

When the system is filled for the first time, the filter housing 200 is degassed via the orifice 222 and the duct 224 with the two segments 225 and 226. Similarly, the pump 100 is degassed via the orifice 130.

When the pump 100 is stopped, the housing 200 defines a static fuel reserve.

Furthermore, as mentioned above, the duct 224 forms a siphon suitable for sucking away the fuel present in the central cavity 220 towards the inlet chamber 240, thereby preventing said fuel being sucked into the inside of the pump 100 via the degassing orifice 130.

It should also be observed that the siphon formed by the duct 224 is assisted in this function by the internal pressure which exists inside the pump 100 when it is stopped.

FIG. 2 shows a variant embodiment of the present invention which differs from the above-described embodiment shown in FIG. 1 essentially in that the return duct 290 is omitted and a pressure regulator 400 is provided on the outlet of the pump, and more precisely on the branch connection duct 270 used for feeding the driving Venturi 262 of the jet pump 260.

The pressure regulator 400 is designed to open and allow flow from the outlet of the pump 100 towards the driving Venturi 262 whenever the pressure at the outlet from the pump 100 is greater than a threshold, and on the contrary it closes so as to prevent this flow whenever the outlet pressure from the pump 100 is below the above-mentioned threshold.

The regulator 400 can be implemented in various conventional ways. It is therefore not described in detail below.

Nevertheless, it should be observed that the regulator 400 preferably comprises a housing which houses a flexible diaphragm urged both by a rated resilient member so as to bear against an outlet nozzle, and also by the fuel pressure that exists in the branch connection duct 270 so as to move away from said outlet nozzle.

Thus, when the force generated on the diaphragm by the pressure that exists in the branch connection duct 270 is greater than the force generated by the rated resilient member, then the flexible diaphragm is lifted off the outlet nozzle so as to allow flow towards the driving Venturi 262, thereby feeding the pump 260.

In contrast, when the force generated by the flexible diaphragm of the pressure regulator 400 by the pressure that exists in the duct 270 is less than the force applied by the rated resilient member, then the diaphragm is pressed against the outlet nozzle so as to prevent the jet pump 260 being fed.

The embodiment shown in FIGS. 3 and 4 is described below.

Firstly, this embodiment differs from those described above with reference to FIGS. 1 and 2 by the fact that it comprises a pump 100 with a jet pump 260 integrated therein and having its driving Venturi fed via a pressure stage of the pump 100 and located so as to feed the inlet chamber 240 of the filter as described above with reference to FIGS. 1 and 2.

Secondly, the embodiment shown in FIGS. 3 and 4 differs from the embodiments described above with reference to FIGS. 1 and 2 by the fact that it has a filter 210 which instead of being in the form of an annulus surrounding the pump 100 is in the form of a crescent located on one side of the pump 100.

The embodiment shown in FIGS. 3 to 4 makes use of essentially the same characteristics as those described above with reference to FIGS. 1 and 2, and in particular it has a filter inlet chamber 240 fed by the jet pump 260 and provided with a degassing orifice 222 which opens out into a siphon-forming duct 224, and the degassing orifice 130 of the pump 100 is placed in the environment of the opening 227 of the siphon 224.

The description below relates to improvements in accordance with the present invention that are specific to the jet pumps 260.

These improvements apply in particular to the embodiment shown in FIGS. 3 and 4.

Accompanying FIG. 5 shows the conventional structure for a jet pump.

Such a conventional jet pump, sometimes also referred to as a liquid ejector, is constituted in outline by the following coaxial elements:

a first converging Venturi 262 referred to as the driving Venturi and fed with fluid under pressure;

a second converging Venturi 267 referred to as the take-up Venturi surrounding the first and connected to a suction inlet 264 of the device;

a cylindrical section 268 referred to as the mixer; and

a diverging end portion 269 acting as a diffuser.

The throat of the driving Venturi 262 is generally located slightly upstream from the throat of the take-up Venturi 267, or else level with the throat of the take-up Venturi 267, or indeed where the throat of the take-up Venturi 267 joins the mixer 268.

The flow feeding the driving Venturi 262 constitutes the driving flow of the ejector. In this Venturi, pressure energy is transferred into kinetic energy. The driving fluid at the outlet is thus in the form of a jet at high speed. By turbulent exchange of momentum, this jet entrains a quantity of liquid through the take-up Venturi 267, with this quantity constituting the flow rate sucked in by the ejector. Within the mixer 268, the exchange of momentum between the driving fluid and the sucked-in fluid continues and comes to an end, with the speeds of these two jets progressively becoming equal. Ignoring losses, this mixing operation takes place at constant pressure. In the end diverging portion 269, a fraction of the kinetic energy of the mixture is converted into pressure energy by diffusion.

Known jet pump devices have already given good service. Nevertheless, they do not always give full satisfaction.

In particular, the Applicant has found that known jet pumps do not operate under satisfactory conditions when there is a high level of back pressure on the outlet from the diffuser 269.

The present invention now has an additional object of proposing a novel jet pump that makes it possible to eliminate the drawbacks of the prior art.

This object is achieved in the context of the present invention by a jet pump in which the take-up nozzle 267 is connected directly to the diffuser, without any intermediate mixer.

According to another advantageous characteristic of the present invention, the jet pump has a large diffuser.

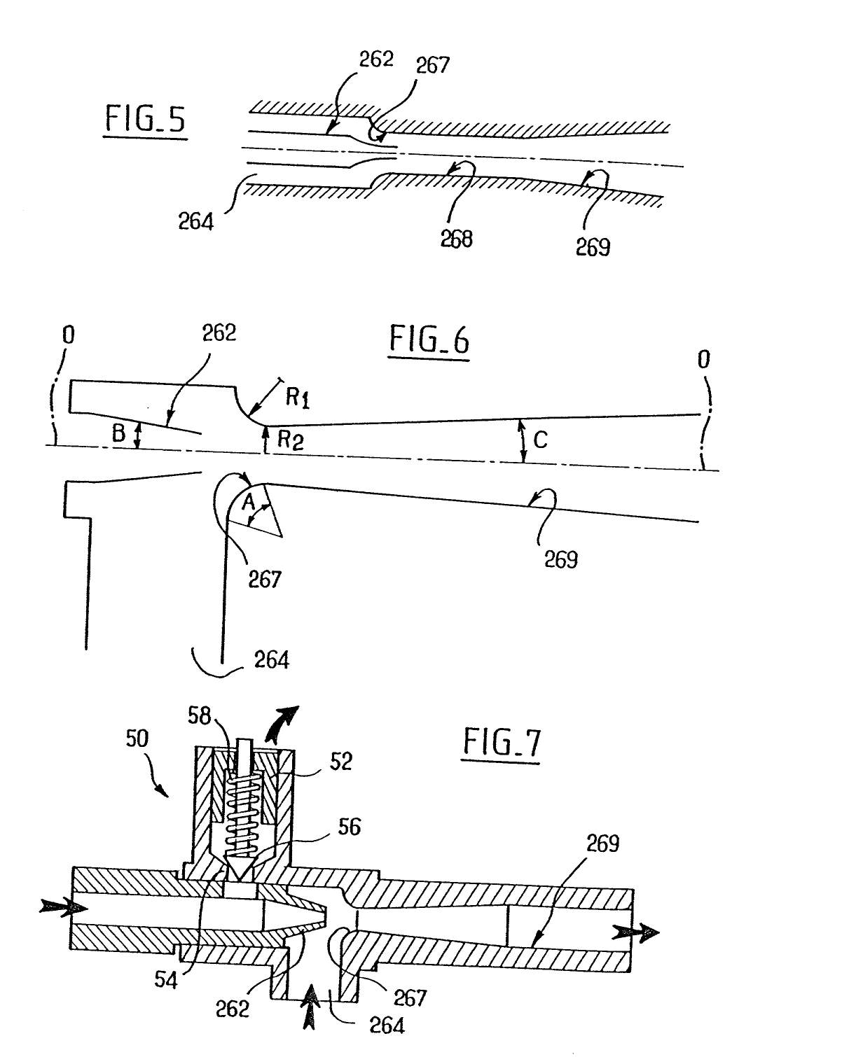

Accompanying FIG. 6 shows a body defining a channel centered on an axis O-O and comprising a first converging Venturi 262 forming a driving Venturi fed with fluid under pressure, a second converging Venturi 267 forming a take-up Venturi surrounding the first and connected to a suction inlet 264 of the device, and an end diverging portion 269 constituting a diffuser.

As mentioned above, the jet pump of the present invention is thus characterized by the absence of any mixer between the second converging Venturi forming a take-up Venturi 267 and the end diverging portion 268 forming a diffuser.

In the context of the present invention, the driving Venturi 262 is preferably conical in shape, presenting a length lying in the range 4 millimeters (mm) to 8 mm, and very advantageously a length that is about the same as the diameter of the suction inlet 264.

The end of the driving Venturi 262 forming the outlet nozzle of the throat is preferably situated at a distance lying in the range 1 mm to 3 mm form the take-up Venturi.

The convergence angle B of the driving Venturi 262 preferably lies in the range 0° to 30°, and very advantageously is about 5°.

The take-up Venturi 267 is preferably defined by a toroidal cap. The radius of curvature R1 of this toroidal cap 267 preferably lies in the range 1 mm to 2 mm, and very advantageously is about 1.6 mm. The curvature R1 of said toroidal cap is preferably tangential to the diffuser 269.

Furthermore, the inside radius R2 of the take-up Venturi 267, at its smallest section, preferably lies in the range 1.8 mm to 3.0 mm, and very advantageously is about 2.0 mm to 2.6 mm.

Furthermore, the toroidal envelope of the take-up Venturi 267 preferably occupies an angle A lying in the range 30° to 60° and very advantageously abut 45°.

The end diverging portion forming a diffuser 269 is preferably defined by a conical envelope.

The length of the diffusing tube 269 preferably lies in the range 10 mm to 40 mm, and is very advantageously about 18 mm.

Furthermore, the convergence angle C of the diffusing tube 269 preferably lies in the range 2° to 10° and very advantageously it is about 4°.

FIG. 7 shows a variant embodiment in which the jet pump body is fitted with a valve 50 designed to open in the event of the pressure in the driving Venturi 262 being too high.

The valve 50 is formed in a length of tube 52 extending radially relative to the axis O-O and connected to the body of the jet pump upstream from the converging Venturi 262 forming the driving Venturi.

The tube 52 thus defines a chamber which opens out into the driving Venturi 262. More precisely, the above-specified chamber defines a valve seat 54 facing radially outwards with a valve member 56 urged thereagainst by a spring 58.

In the variant shown in FIG. 7, the valve member 56 is generally mushroom-shaped with a flared head resting against the valve seat 54 and a valve stem of smaller section serving to guide sliding of the valve member 56 in a direction that is radial relative to the axis O-O and also serving to support the spring 58.

Naturally, the valve 50 can be implemented in numerous different ways.

The valve is designed to open by the valve member 56 lifting off the valve seat 54 in the event of the pressure inside the driving Venturi 262 becoming excessive, and to close whenever the pressure inside the driving Venturi 262 drops below a determined threshold.

Naturally, the present invention is not limited to the particular embodiment described above, but extends to any variant in compliance with the spirit of the invention.

1/ A fuel drawing-off device for a motor vehicle tank, the device comprising a drawing-off pump and a fine filter placed upstream from the pump, wherein the drawing-off pump is a pilot operated pump.

2/ A device according to claim 1, wherein the drawing-off pump is pilot operated to deliver a varying flow rate such that the flow of fuel passing through the drawing-off pump is close to the minimum flow required for proper operation of the device, as a function of the instantaneous consumption of the engine.

3/ A device according to claim 1, wherein the drawing-off pump is a brush-less pump.

4/ A device according to claim 1, wherein the drawing-off pump is pilot operated in such a manner that the flow passing through it and through the fine filter is substantially equal to the instantaneous consumption of engine.

5/ A device according to claim 1, having a reserve from which the drawing-off pump draws fuel, and a jet pump designed to feed the reserve on receiving an inlet flow coming directly or indirectly from the outlet of the drawing-off pump, said drawing-off pump being pilot operated in such a manner that the flow passing through it is substantially equal to the sum of the instantaneous consumption of the engine thus the auxiliary flow required for operating the jet pump.

6/ A device according to claim 1, wherein the drawing-off pump is pilot operated by a pressure or flow rate sensor.

7/ A device according to claim 1, wherein the drawing-off pump is pilot operated by a reference value coming from an engine control module.

8/ A device according to claim 1, wherein:
the housing of the filter possesses a degassing orifice in its top portion;
the drawing-off pump also possesses a degassing orifice; and
the filter housing is fitted with a duct which extends the degassing orifice of the housing, opens out into a cavity common to the degassing orifice of the pump, and possesses an opening situated at a height equal to or lower than the height of the degassing orifice of the pump, said duct being shaped to constitute a siphon suitable for taking fuel in the vicinity of its opening towards the inside of the filter housing whenever the drawing-off pump is stopping.

9/ A device according to claim 8, wherein the inlet chamber of the filter housing is fed and pressurized by a jet pump.

10/ A device according to claim 8, wherein the drawing-off pump is a pump of the turbine or centrifugal type.

11/ A device according to claim 9, wherein the jet pump is fed by a branch connection connected to the outlet of the drawing-off pump.

12/ A device according to claim 9, wherein the jet pump is fed by a return duct receiving the fuel that is not consumed by the engine.

13/ A device according to claim 9, wherein the jet pump is fed both by a branch connection connected to the outlet of the drawing-off pump and by a return duct which receives the fuel that is not consumed by the engine.

14/ A device according to claim 9, wherein the jet pump has its suction flow inlet fitted with a non-return valve.

15/ A device according to claim 9, wherein the jet pump has its outlet extended by a vertical tube whose end is situated close to the top of the filter housing.

16/ A device according to claim 8, wherein a return duct receiving the fuel that is not consumed by the engine opens out into the inlet chamber of the filter housing.

17/ A device according to claim 8, wherein the siphon-forming duct has a horizontal segment which communicates with the degassing orifice of the filter housing, and a generally vertical segment whose bottom opening is situated in the vicinity of the bottom of a cavity defined by the fine filter housing and in which the drawing-off pump is situated.

18/ A device according to claim 8, wherein the opening of the siphon-forming duct is situated below the level of the degassing orifice of the drawing-off pump.

19/ A device according to claim 8, wherein the diameter of the siphon-forming duct is greater that the diameter of the degassing orifice of the drawing-off pump.

20/ A device according to claim 8, wherein a pressure regulator is placed on a duct connected to the outlet of the drawing-off pump and connected to the driving Venturi of a jet pump serving to feed the inlet chamber of the filter housing.

21/ A device according to claim 8, wherein the degassing orifice of the filter housing opens out into the inlet chamber thereof.

22/ A device according to claim 8, wherein the degassing orifice of the drawing-off pump is situated at the bottom of the drawing-off pump housing in a cavity defined by the filter housing.

23/ A device according to claim 1 of the type including a jet pump having a first converging Venturi forming a driving Venturi fed with fluid under pressure, a second converging Venturi forming a take-up Venturi surrounding the first Venturi and connected to a suction inlet, and an end diverging portion acting as a diffuser, wherein the second converging Venturi forming a take-up Venturi is connected directly to the end diverging portion acting as a diffuser, without any intermediate mixer.
